(19) United States
(12) Patent Application Publication
(10) Pub. No.: US 2023/0020740 A1
(43) Pub. Date: Jan. 19, 2023

(54) Wildlife Feeder

(71) Applicant: Ronald C. Smith, Sadieville, KY (US)

(72) Inventor: Ronald C. Smith, Sadieville, KY (US)

(21) Appl. No.: 17/373,418

(22) Filed: Jul. 12, 2021

(51) Int. Cl. A01K 5/02

(52) U.S. Cl. CPC A01K 5/0225

(57) ABSTRACT

A timed or remotely operated wildlife feeder which delivers feed such as whole fruit and nuts by emptying feed storage containers into a chute to deliver feed using potential energy and gravity instead of kinetically broadcasting the feed.

### FIELD OF TECHNOLOGY

The apparatus of the present application relates generally to feeding systems, and more specifically to scheduled feeding systems.

### BACKGROUND

It has long been a practice of hunters, photographers, and wildlife enthusiasts to bait areas with food to attract specific species. However, it is difficult to do so and control the scent of humans on the bait or feeding apparatus. Any unnatural scent has a tendency to ward off many species of wildlife. Additionally, bait is often placed hours before the target species forages and is subsequently subject to being depleted by undesirable species before the target species detects the bait. Many feeders simply dump the bait below the device, leaving it in an unnatural accumulation that is unattractive or alarming to the target species.

One significant problem with leaving a large food pile is the possibility of spreading disease within a group, such as a herd of deer. Diseases can quickly spread between animals that visit a large food pile as visitors pick over the same food pieces. In an effort to limit the spread of diseases that can have an adverse impact on economically important or protected wildlife some states have instituted regulations restricting feed stations. In the state of Michigan, for example, no more than two gallons of any type of food item are allowed to be on the ground at a feeding station at any time. Legal restrictions such as this make it even more difficult for the “weekend hunter” to manage a feeding station. It is therefore useful to have a means for automatically dispensing the right amount food at a feeding station each day.

Other feeders spread the feed about the feeder by mechanically propelling the feed. These feeders are noisy, alarming to nearby wildlife, and consume a significant amount of electricity. No spread feeders permit the use of larger feed such as fruit due to the significantly higher energy required to propel them from the spreader, thus limit themselves to grains such as corn.

It is an object of the feed spreader of the present application to spread larger feed such as nuts and fruit so as to have them roll away from the feeder in a more natural pattern as would be found beneath a tree to encourage foraging and decrease stress.

It is a further object of the feed spreader of the present application to actuate in a manner that creates very little sound from the device itself so as to not alarm nearby wildlife.

It is a still further object of the feed spreader of the present application to operate while consuming very little power.

### BRIEF DESCRIPTION OF THE DRAWINGS

FIG. 1 illustrates a perspective view of the wildlife feeder.

FIG. 2 illustrates a perspective exploded view of the wildlife feeder.

FIG. 3 illustrates a cutaway view of the planar plate-drive shaft joint of the wildlife feeder.

FIG. 4 depicts an exploded view of a feed storage compartment and the planar plate of the wildlife feeder.

FIG. 5 depicts a perspective cutaway view showing the feed storage containers within the housing of the wildlife feeder.

FIG. 6 depicts a cutaway view of a loaded storage container of the wildlife feeder in a closed arrangement.

FIG. 7 depicts a a cutaway view of loaded storage container of the wildlife feeder in an open arrangement above the feed catch and delivery chute.

FIG. 8 depicts a side plan view of the hatch door of an open storage container of the wildlife feeder using the feed catch to close the hatch as the storage container is rotated across the feed catch.

FIG. 9 depicts a cutaway perspective view of an emptied storage container partially rotated into a closed arrangement as its hatch passes across the feed catch and a loaded storage container partially rotated above the feed catch where it will open as the catch enters the feed catch.

FIG. 10 depicts a side view of a loaded storage container above the feed chute.

### DETAILED DESCRIPTION OF THE PREFERRED EMBODIMENTS

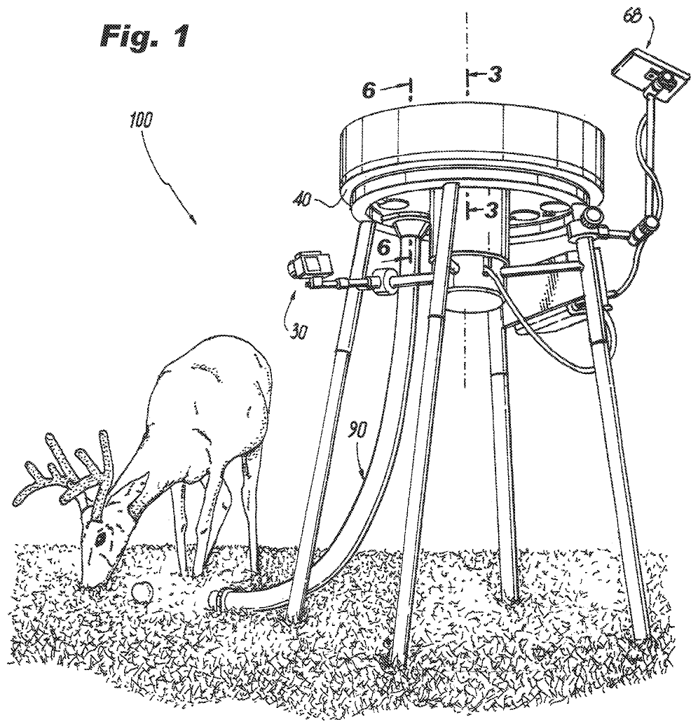

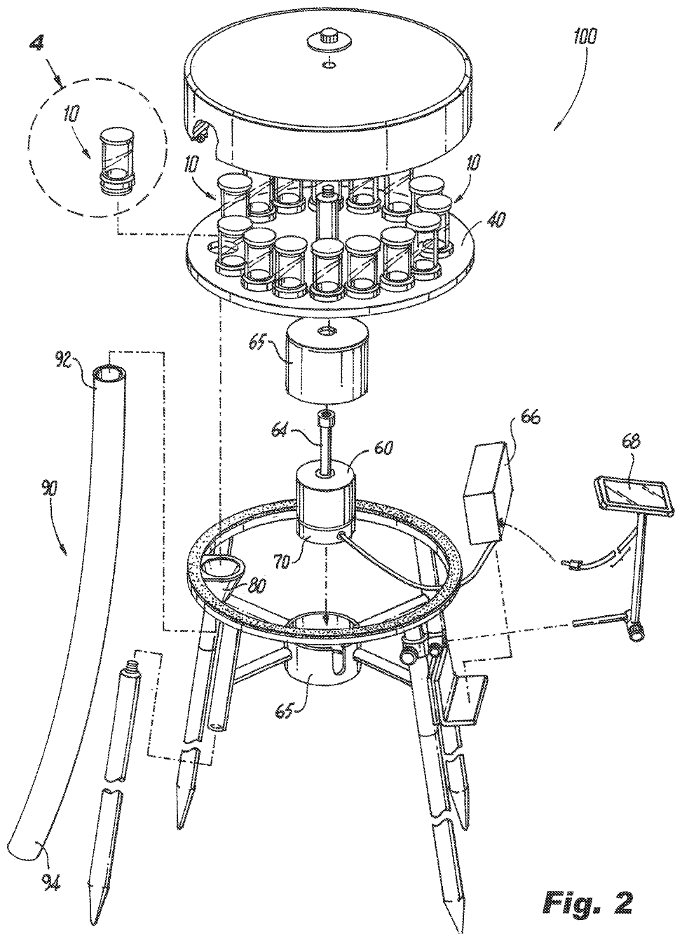

The present application, as depicted in FIGS. 1 and 2, discloses a device 100 for spreading feed to attract wildlife. The feed is preferably stored in a plurality of storage compartments 10 mounted above a delivery system. The storage compartments 10 protect the feed from the weather and from pesky foragers such as squirrels. Each feed storage compartment 10 possesses an exit orifice 12 at its base 18 to allow the contents to empty out of the base 18 of the compartment 10 but is otherwise sealed at its top 14, side walls 16, and around the exit orifice 12 at the base 18.

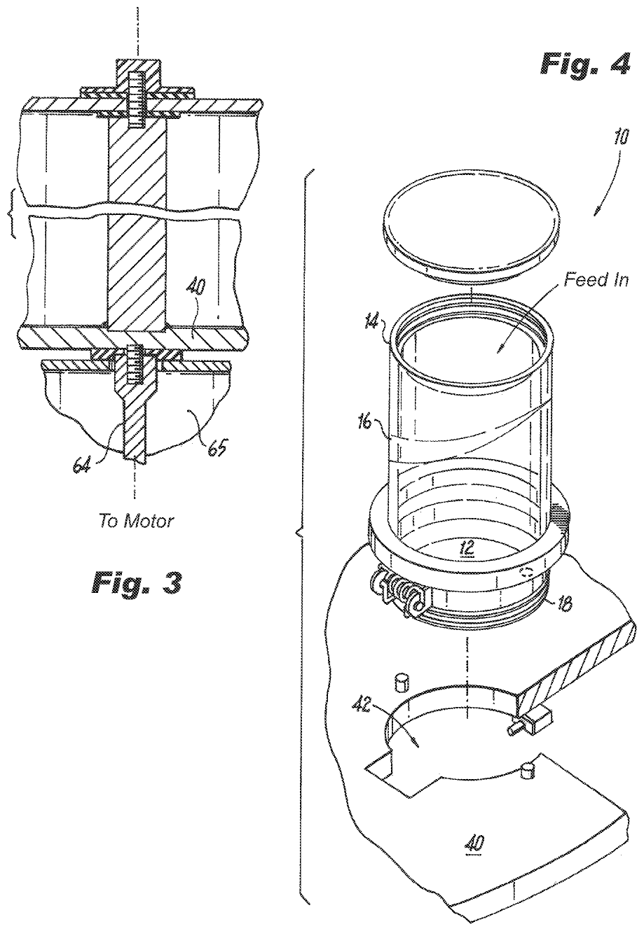

A stop is arranged at the base of a compartment 10 at its exit orifice 12 to prevent the emptying of the compartment 10 through its exit orifice 12 until that action is desired. In an embodiment, the storage compartments 10 are arranged about the vertical axis 3 of the device and atop a planar plate 40 which acts as the stop. As shown in FIGS. 3 and 4, the planar plate 40 is configured with a plate orifice 42 that is rotated by a motor 60 to align the plate orifice 42 with a compartment exit orifice 12 so as to permit the emptying of the feed storage compartment 10. In an embodiment as depicted in FIG. 3, the plate 40 is rotated incrementally the turning of a shaft 64 by a small battery powered assembly drive motor 60. The motor driven shaft 64 which engages the assembly drive motor 60 is in communication with or otherwise coupled to the planar plate 40 so as to cause its rotation according to any technique or mechanism which is known by those skilled in the art and suitable for the purpose. The driven shaft 64 may be welded to the planar plate 40 or otherwise affixed to it by a threaded connection or other coupling arrangements known to those skilled in the art. In some embodiments, the driven shaft 64 may be removably affixed to the planar plate 40 for assembly and disassembly to aid in the rapid replacement of the motor 60 and the plate 40. Techniques for removably affixing the shaft 64 to the plate are well known in the mechanical arts and herein incorporated by reference.

Preferably, the motor 60 is configured so as to drive the shaft 64 in a plane of rotation parallel to the plate 40. Ideally, the shaft 64 is affixed to the center of the plate 40 and is substantially perpendicular to the plane of the plate 40. A low noise motor 60 is preferred so as to not discourage foraging animals from approaching the device 100. Preferably the battery 66 and motor 60 are housed within a motor cover 65 so as to protect them from the elements. Materials utilized with the device should be weather resistant as well. The plate 40 should be constructed from material(s) which allow the minimization of mass so as to require little torque from the motor 60 to turn the plate 40.

In a further embodiment, a hatch door 45 is arranged beneath each feed storage compartment 10 and hingedly affixed at each exit orifice 12. Each individual hatch door 45 is individually controlled. In a still further embodiment, a solenoid is utilized to displace a compartment stop and allow the feed to empty from the feed compartment 10.

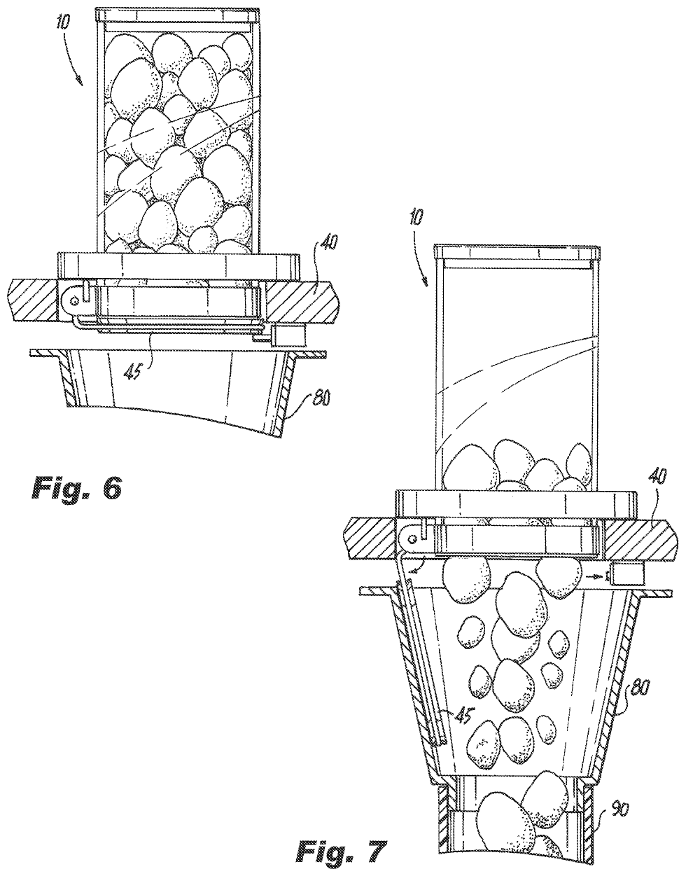

As shown in FIGS. 6 and 7, the opening of each storage compartment 10 is controlled to optimize feeding at the user's discretion. In one embodiment, the emptying of feed storage compartments 10 is controlled by a timer. The timer is housed within a timer housing 70 and is mechanical in an embodiment or, in a further embodiment, utilizes a control system employing a microprocessor/microcontroller to rotate the plate 40. In yet a further embodiment, a microprocessor/microcontroller housed within the timer housing 70 would control the solenoids. In various embodiments, the control system may initiate the emptying of the feed storage compartments 10 by direct command by a remote user, upon the occurrence of scheduled events, or both. A controlled release of feed permits the user to time the release so as to encourage foraging by the target species since some species forage in the morning, some in the afternoon, while others may forage at night. Releasing the bait at the wrong time could result in a depletion of the bait prior to the arrival of the target species. The presence or scent of the wrong species could also discourage foraging by the target species. The device 100 can optionally be outfitted with a camera system 30, such as a wireless trail camera, which a user could monitor to ascertain the preference for particular types of bait by target species or to avoid the release of bait that is attracting the wrong species. In an embodiment, different feed storage compartments 10 can be stocked with dissimilar feed so that the user can select from a plurality of feeds based upon user preference and select the appropriate compartment to empty.

The motor 60 is ideally powered by a battery 66. The battery 66 may be any of the battery types known to those skilled in the art. In a further embodiment, the battery 66 may be charged in part or in whole by a photovoltaic solar panel 68. Ideally, the controlled emptying of the storage compartments 10 consumes little power to increase the operable period of the device 100 and minimize human intervention. The device 100 is also intended to operate with as little noise as possible to avoid scaring wildlife. Either rotary or linear DC solenoids could be utilized depending on the method of opening the compartment 10 and are well known to those skilled in the art. A low power solenoid of approximately 5-7 V could be utilized to control the opening of the compartment hatch doors 45. Boosting into a capacitor and then discharging that capacitor through the solenoid permits the use of a low voltage battery source since solenoids are typically driven by short, high-current pulses.

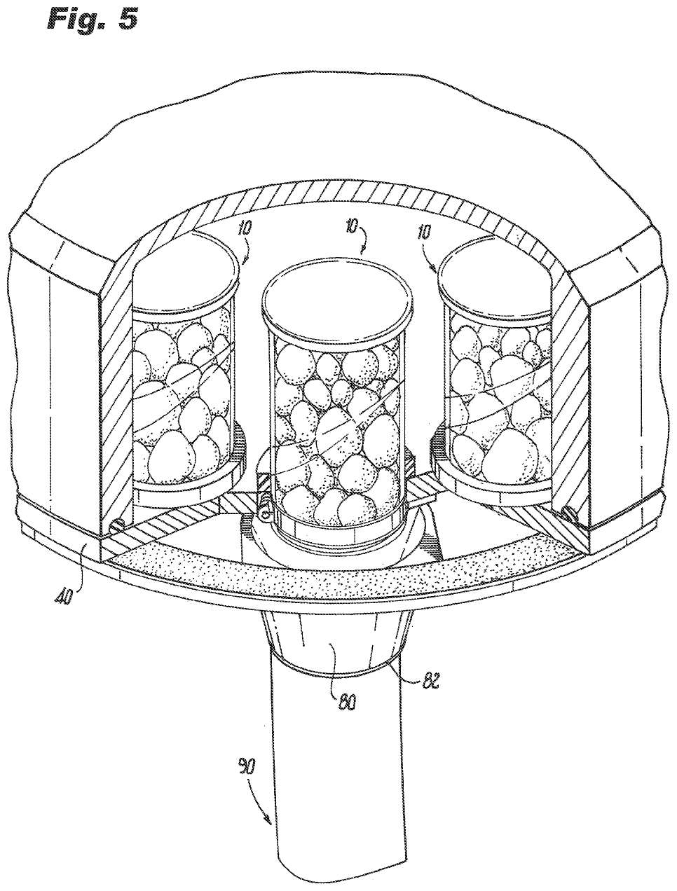

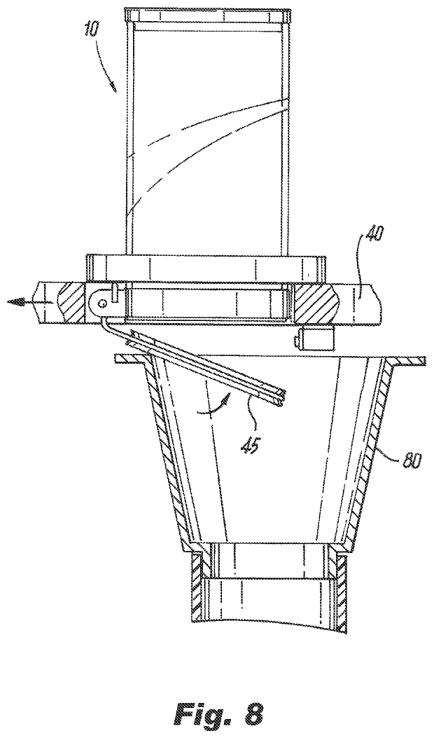

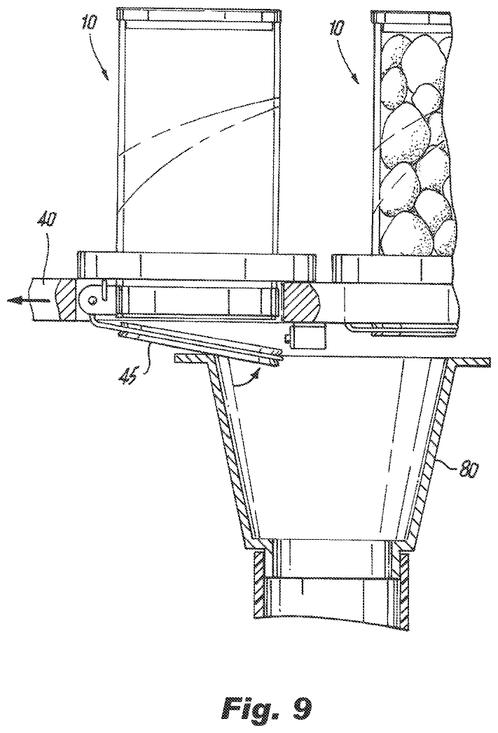

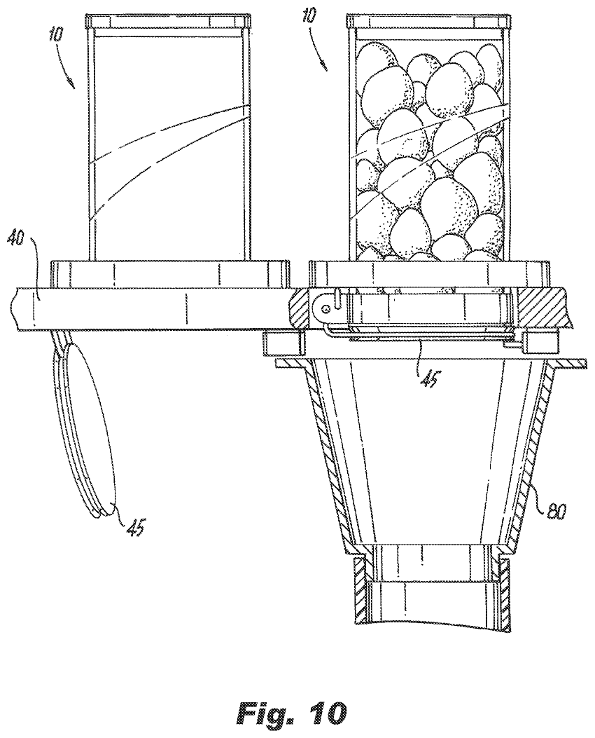

In an embodiment as shown in FIGS. 5 and 8-10, each feed storage compartment 10 is tubular. Varying diameters of the tubular feed storage compartment 10 could be selected depending upon the size of the feed selected. For example, a tube 10 with a diameter of at least 10 mm is likely required for an apple. A feed catch 80 is positioned beneath the plate orifice 42 and receives feed from the opened feed storage compartments 10. In an embodiment, the feed catch 80 is an inverted cone with a catch exit orifice 82 arranged at the lowest point of the catch 80. The feed passes from the feed catch 80 through the catch exit orifice 82 and is received by a feed delivery chute 90. The feed delivery chute 90 possesses a first end 92 arranged to receive feed funneled by the feed catch 80 to the delivery chute 90. The feed delivery chute 90 descends down from the feed delivery chute first end 92 and away from the vertical axis 6 extending through the center of the plate orifice 42 which runs parallel to the vertical axis 3 of the device 100 and descending toward the ground to terminate at a feed delivery chute second end 94 from which the feed is discharged from the feed delivery chute 90. The substantially round shape of the feed, i.e. fruit and nuts, causes them to roll as they descend down the feed delivery chute 90 and out of the chute's second end 94. As the feed strikes the ground, its inertia and roll carries it away from the device 100 so that the feed may be dispensed away from the vertical axis 3 of the device 100 without scaring the foraging wildlife by unnaturally releasing the feed from the device. The induced roll of the feed also prevents the accumulation of feed in a feed pile beneath the device 100.

An example of an apparatus for dispensing bulky food items in accordance with one embodiment of the invention utilizing a mechanical or electromechanical release mechanism would incorporate a single hatch door 45 (also known as a trap door 45) for a chamber 10. In this example, the device utilizes mechanical and electromechanical release mechanisms well known to those skilled in the art, e.g. solenoid, a recoil spring, a solenoid swing arm, a solenoid push pin, a stop block, a mechanical timer or an electromechanical release mechanism utilizing a control system.

In a further embodiment, a device 100 coupled with a trail camera 30 could be utilized to remotely cause the device 100 to feed wildlife found on camera or to lure wildlife within the view of the camera 30. Such a system could be monetized so as to permit remote viewers feed wildlife on demand or in a timed manner via computer or smart phone communications by paying a nominal fee. Useful payment technologies are known in the relevant arts. Such a monetization model would prove useful to help financially support zoos, wildlife refuges, and national parks by permitting users to remotely interact with animals by feeding them. Feedings could be scheduled and users permitted to purchase such scheduled feedings so as to not overfeed or make wildlife unnaturally reliant upon the artificial feedings.

In operation, a signal is received from a transmitter which is activated at the holder's discretion. The device 100 processes (filters) incorrect signals using a microprocessor. if it recognizes a correct signal, the microprocessor then activates the relays which in turn activate a driven external circuit, In the present instance, the typical driven circuit is a wildlife feeder motor or solenoid. The motor shaft is driven for a predetermined time by the microprocessor. Alternatively, the solenoid is actuated for a brief period of time so as to open the bait chamber bottom, possibly using a trap door. The system may actuate a process by which a capacitor or other means to boost the solenoid is actuated first so as to minimize the power drain on the battery.

Signals could be received by the device using a receiver or transceiver which communicates via cellular communications. Alternatively, in remote locations satellite communications may be required. In a further alternative embodiment, satellite supported cellular communications could be employed. Alternatively communication protocols utilizing IEEE 802.22 could be employed as they work over a range of several miles. Alternative short-range communication technologies, see table 1 below, could be employed when monitoring the device within sight of the user. Longer range communication technologies such as radio could also be employed. Some systems report the ability to control devices at a range of up to 200 km.

TABLE 1
SHORT RANGE WIRELESS TECHNOLOGIES

| Technology | Frequency | Range | | Features |
|---|---|---|---|---|
| Bluetooth | 2.4 GHz | <200 | m | Low-power |
| Cellular | Common | Several km | | Longer range |
| | cellular bands | | | |
| IEEE 802.22 | 470 to 768 MHz | Many miles | | Longer range |
| UWB | 3.1 to 10.6 GHz | <10 | m | Low power |
| Wi-Fi | 2.4 and 5 GHz | <200 | m | High speed, ubiquity |
| Wireless HD | 7 GHz and | <10 | m | Very high speed |
| | 60 GHz | | | |
| Wireless USB | 2.4 GHz | <10 | m | Proprietary protocol |

The feeder of the present application is useful for attracting wildlife for hunting, recreational photography, or the like. The feeder is especially useful for behavioral modification of wildlife species such as whitetail deer. It should be clear to those experienced. in the art that the device of the present application can be applied and extended without deviating from the scope of the present invention.

What is claimed is:

1. A feed spreader comprising:
a. at least one hollow feed storage compartment having a length, width, height, walls, base, and top, wherein said compartment possesses an opening at said base closed by a stop and arranged to permit the gravity assisted emptying of said compartment when said stop is removed;
b. at least one chute which receives said feed selectively released from said compartment, wherein said chute possesses a first chute end arranged proximally to said base of at least one said compartment so as to receive said released feed, a second chute end arranged distally to said base, and a chute body which descends from said first chute end and away from a vertical axis of said fees spreader to said second chute end.

2. The feed spreader of claim 1, wherein said spreader is powered by at least one of a battery, a photovoltaic solar panel, and a wind turbine.

3. The feed spreader of claim 2, wherein said stop displaced by at least one of a signal received from a control system and a mechanical timer.

4. The feed spreader of claim 3, wherein said stop displacement is physically accomplished by at least one of a solenoid and a geared motor.

5. The feed spreader of claim 1, wherein said stop is comprised of a planar plate arranged at the base of said at least one compartment and having at least one orifice extending there through from a top surface of said plate to a bottom surface of said plate wherein said plate is rotated about said vertical axis of said feeder so as to rotate said orifice beneath said at least one compartment so as to permit the contents of said at least one compartment to pass through said stop.

6. The feed spreader of claim 4, wherein said control system is configured to receive wireless commands to dispense feed from a user.
